(19) United States
(12) Patent Application Publication
(10) Pub. No.: US 2025/0116627 A1
(43) Pub. Date: Apr. 10, 2025

(54) METHOD OF RECONFIGURING OXYGEN CONCENTRATION ON METAL OXIDE AND METHOD OF OPERATING GAS SENSORS USING THE METHOD

(71) Applicant: Seoul National University R&DB FOUNDATION, Seoul (KR)

(72) Inventors: Jong-Ho LEE, Seoul (KR); Gyuweon JUNG, Seoul (KR)

(21) Appl. No.: 18/811,886

(22) Filed: Aug. 22, 2024

(30) Foreign Application Priority Data
Oct. 6, 2023 (KR) 10-2023-0133706

(51) Int. Cl. G01N 27/407

(52) U.S. Cl. CPC G01N 27/407

(57) ABSTRACT

Provided is a method for reconfiguring the oxygen concentration of a metal oxide. The method includes the steps of: (a) predetermining the oxygen reconfiguration voltage to ensure that the metal oxide has the required electron concentration or oxygen adsorption or desorption energy for a chemical reaction; (b) applying voltages to the contact and separation electrodes according to the oxygen reconfiguration voltage; (c) predetermining the oxygen concentration recovery voltage based on the chemical reaction; and (d) after the chemical reaction, applying voltages to the contact and separation electrodes according to the oxygen concentration recovery voltage. This method allows for the reconfiguration of the oxygen concentration in the metal oxide by adjusting the electron concentration and controlling the oxygen adsorption or desorption energy of the metal oxide.

### TECHNICAL FIELD

The present invention relates to a method of reconfiguring the oxygen concentration of metal oxide and a method of driving a gas sensor using the same. More specifically, the method of reconfiguring the oxygen concentration on the metal oxide according to the present invention uses an electric field formed in the metal oxide according to the application of voltage to manipulate the electron concentration and oxygen adsorption or desorption energy of the metal oxide, thereby reconfiguring the oxygen concentration in the metal oxide.

In addition, the method of driving a gas sensor according to the present invention is configured to reconfigure the oxygen concentration or oxygen content on the metal oxide, thereby manipulating the oxygen vacancy of the metal oxide and oxygen species adsorbed on the metal oxide and controlling chemical reactions affected by them.

### BACKGROUND ART

Recently, demand and interest in metal oxides are increasing as they are actively used as catalysts, energy storage, and gas sensing materials, etc. These fields mainly utilize the chemical reactions of the metal oxides. Since the electrical conductivity, electron concentration, and work function of metal oxides vary depending on the oxygen ratio of the material, methods of controlling the properties of the material by manipulating the oxygen ratio have been actively studied.

When the oxygen ratio in the metal oxide decreases, oxygen vacancies are generated in the metal oxide. And, when the oxygen ratio in metal oxide increases, the oxygen vacancy concentration decreases and adsorbed oxygen species are generated. Oxygen contents on metal oxide, which are oxygen vacancies existing in metal oxide and oxygen species adsorbed on metal oxide, have a significant effect on the oxidation-reduction reaction of metal oxide.

Metal oxides are actively used as heterogeneous catalyst that adsorb gases on the surface and convert the adsorbed gases into other gases. One of the most researched areas in the field of heterogeneous catalysts is research on methods to control oxygen vacancy concentration. Several studies have shown that many oxidizing gases are adsorbed onto oxygen vacancies present in metal oxides. This discovery led to the use of metal oxides rich in oxygen vacancy as catalysts for the conversion of carbon dioxide, a representative oxidizing gas and a gas that causes global warming.

Metal oxides are also actively used in the field of gas sensors that can detect and prevent air pollution. Metal oxide is used as a gas sensing material in gas sensors. Gas sensors convert the chemical reaction generated between the metal oxide and gas into electrical signals. In order for a gas sensor to respond sensitively to a low concentration of gas, it must be easy for the gas to be absorbed into the metal oxide. As a method of this, a method of increasing the concentrations of oxygen vacancy in metal oxide and oxygen species adsorbed on metal oxide was used.

Efforts have been made to control oxygen vacancy and oxygen species concentration in various fields using metal oxides. Previously, techniques such as high-energy particle bombardment, high temperature sintering, ion doping, and heterostructures were used to control the concentration of oxygen vacancies in metal oxide. These existing methods had problems requiring harsh conditions such as high temperature and high vacuum. Additionally, these existing methods had the problem that it was difficult to adjust the oxygen content again or restore it to its original state after adjusting it.

Therefore, the present invention seeks to propose a method of reconfiguring the oxygen concentration of metal oxide in a device containing a metal oxide by manipulating the electron concentration in the metal oxide.

### SUMMARY OF THE INVENTION

In order to solve the above-mentioned problems, the object of the present invention is to provide a method of reconfiguring the oxygen concentration in the metal oxide, which manipulates the potential difference between the contact electrode and the separation electrode to adjust the electron concentration in the metal oxide and the adsorption or desorption energy of oxygen to the metal oxide.

In addition, another object of the present invention is to provide a method of driving a gas sensor that can improve the accuracy of detection and measurement of the gas sensor by applying the method of reconfiguring the oxygen concentration of metal oxide described above to the gas sensor.

Additionally, another object of the present invention is to provide a method of driving a device in which the metal oxide is used as a catalyst for the chemical reaction of the device by applying the method of reconfiguring the oxygen concentration of metal oxide described above to the device.

In the first aspect of the present invention, a method of reconfiguring oxygen concentration of a metal oxide in an electronic device including the metal oxide, a contact electrode in contact with the metal oxide, and a separation electrode electrically isolated from the metal oxide, may include the following steps of: (a) determining an oxygen reconfiguration voltage required to enable the metal oxide to have the necessary electron concentration or oxygen adsorption or desorption energy needed for any given chemical reaction; and (b) applying voltages to the contact electrode and the separation electrode so that the potential difference between the contact electrode and the separation electrode becomes the oxygen reconfiguration voltage, and the oxygen concentration in the metal oxide may be reconfigured by manipulating the electron concentration in the metal oxide and adjusting the oxygen adsorption or desorption energy of the metal oxide, and the chemical reaction may be a reaction utilizing oxygen vacancies in the metal oxide or oxygen species adsorbed on the metal oxide.

In the method of reconfiguring the oxygen concentration in the metal oxide according to the first aspect of the present invention, it is preferable that the step (a) may include the steps of: (a1) in case that the chemical reaction to be promoted utilizes oxygen vacancies of the metal oxide, determining a first oxygen reconfiguration voltage required to increase the concentration of oxygen vacancies in the metal oxide; and (a2) in case that the chemical reaction to be promoted utilizes oxygen species adsorbed on the metal oxide, determining a second oxygen reconfiguration voltage required to increase the concentration of the oxygen species adsorbed on the metal oxide.

In the method of reconfiguring the oxygen concentration in the metal oxide according to the first aspect of the present invention, it is preferable that the step (a) may include the steps of: (a3) in case that the chemical reaction to be suppressed utilizes oxygen vacancies, determining a third oxygen reconfiguration voltage required to reduce the concentration of oxygen vacancies in the metal oxide; and (a4) in case that the chemical reaction to be suppressed utilizes adsorbed oxygen species, determining a fourth oxygen reconfiguration voltage required to reduce the concentration of the oxygen species adsorbed on the metal oxide.

In the method of reconfiguring the oxygen concentration in the metal oxide according to the first aspect of the present invention, it is preferable that the method may further include the steps of: (c) determining an oxygen concentration recovery voltage based on the chemical reaction that has occurred in the metal oxide; and (d) after the chemical reaction is completed, applying voltages to the contact electrode and the separation electrode such that the potential difference between the contact electrode and the separation electrode becomes the oxygen concentration recovery voltage, and after the completion of the chemical reaction involving the metal oxide, the oxygen concentration in the metal oxide may be restored to the oxygen concentration before the chemical reaction.

In the method of reconfiguring the oxygen concentration in the metal oxide according to the first aspect of the present invention, it is preferable that the step (c) may include the steps of: (c1) determining a first oxygen concentration recovery voltage required to increase the concentration of oxygen vacancies of the metal oxide when the concentration of oxygen vacancies of the metal oxide is reduced by the chemical reaction; and (c2) determining a second oxygen concentration recovery voltage required to increase the concentration of oxygen species adsorbed on the metal oxide when the concentration of oxygen species adsorbed on the metal oxide is reduced by the chemical reaction.

In the method of reconfiguring the oxygen concentration in the metal oxide according to the first aspect of the present invention, it is preferable that the method may further include the step of (d) supplying energy to the metal oxide utilizing an energy source at least during all or part of manipulation of the oxygen concentration in the metal oxide, in order to promote the process of adjusting the oxygen concentration in the metal oxide.

In the method of reconfiguring the oxygen concentration in the metal oxide according to the first aspect of the present invention, it is preferable that the method may be applied to an array structure in which a plurality of electronic devices are arranged, and the oxygen reconfiguration voltages of the electronic devices constituting the array structure may be determined, respectively.

In the method of reconfiguring the oxygen concentration in the metal oxide according to the first aspect of the present invention, it is preferable that the method may be applied to a device having first and second separation electrodes electrically coupled to each other, and the voltage of the first separation electrode may be manipulated by applying voltage to the second separation electrode of the device so that the potential difference between the first separation electrode and the contact electrode in the device becomes the oxygen reconfiguration voltage.

In the method of reconfiguring the oxygen concentration in the metal oxide according to the first aspect of the present invention, it is preferable that the method may be applied to a device that utilizes a separation electrode as a heat source and generates heat by applying voltage to the separation electrode.

In the second aspect of the present invention, a method of driving a gas sensor configured to detect a target gas, including a metal oxide, a contact electrode in contact with the metal oxide, and a separation electrode electrically separated from the metal oxide, may include the following steps of: (a) predetermining an oxygen reconfiguration voltage depending on the target gas; and (b) applying voltages to the contact electrode and the separation electrode so that the potential difference between the contact electrode and the separation electrode becomes the oxygen reconfiguration voltage, and the electron concentration in the metal oxide may be manipulated and the oxygen adsorption or desorption energy of the metal oxide may be adjusted, in order to reconfigure the oxygen concentration adsorbed on the metal oxide, and the detection reaction of the gas sensor for the target gas may be a reaction using oxygen vacancies of the metal oxide or oxygen species adsorbed on the metal oxide.

In the method of driving the gas sensor according to the second aspect of the present invention, it is preferable that the step (a) may include the steps of: (a1) in case that the target gas of the gas sensor is an oxidizing gas, determining a first oxygen reconfiguration voltage required to reduce the oxygen concentration in the metal oxide and increase the concentration of oxygen vacancies; and (a2) in case that the target gas of the gas sensor is a reducing gas, determining a second oxygen reconfiguration voltage required to increase the oxygen concentration in the metal oxide and increase the concentration of adsorbed oxygen species.

In the method of driving the gas sensor according to the second aspect of the present invention, it is preferable that the method may further include the steps of: (c) predetermining an oxygen concentration recovery voltage based on the target gas of the gas sensor; and (d) applying voltages to the contact electrode and the separation electrode after the detection reaction of the gas sensor is completed, so that the potential difference between the contact electrode and the separation electrode becomes the oxygen concentration recovery voltage, and the oxygen concentration in the metal oxide of the gas sensor consumed by the detection reaction may be recovered to the state before the detection reaction.

In the method of driving the gas sensor according to the second aspect of the present invention, it is preferable that the step (a) may include the step of (a3) in case that the target gas of the gas sensor is a mixture of an oxidizing and a reducing gases, determining a third oxygen reconfiguration voltage for detecting the oxidizing gas and a fourth oxygen reconfiguration voltage for detecting the reducing gas, and the step (b) may perform the primary detection of the oxidizing gas using the third oxygen reconfiguration voltage, and after the primary detection of the oxidizing gas, perform the secondary detection of the reducing gas using the fourth oxygen reconfiguration voltage, and the third oxygen reconfiguration voltage may be a voltage required to reduce the oxygen concentration in the metal oxide and increase the concentration of oxygen vacancies, and the fourth oxygen reconfiguration voltage may be a voltage required to increase the oxygen concentration in the metal oxide.

In the method of driving the gas sensor according to the second aspect of the present invention, it is preferable that the method may be applied to an array structure in which a plurality of gas sensors are arranged, and the oxygen reconfiguration voltages of gas sensors constituting the array structure may be predetermined, respectively, so that the metal oxides of each gas sensor can have different oxygen concentrations.

In the method of driving the gas sensor according to the second aspect of the present invention, it is preferable that the method may further include the step of (f) supplying energy to the metal oxide utilizing an energy source during at least part or all of the period in which the oxygen reconfiguration voltage is applied to the gas sensor, thereby facilitating the adjustment of the oxygen concentration in the metal oxide.

In the method of driving the gas sensor according to the second aspect of the present invention, it is preferable that the method may further include the step of (g) manipulating the electron concentration in the metal oxide by using the potential difference between the contact electrode and the separation electrode during the detection reaction for the target gas, so that the gas detection reaction of the metal oxide can be promoted.

In the third aspect of the present invention, a method of driving a device including a metal oxide used as a catalyst for a chemical reaction, a contact electrode in contact with the metal oxide, and a separation electrode separated from the metal oxide by a dielectric layer, may include the following steps of: (a) applying voltages to the contact electrode and the separation electrode to reduce the oxygen concentration in the metal oxide and increase the concentration of the oxygen vacancies of the metal oxide when the oxygen vacancies of the metal oxide promote a chemical reaction; and (b) applying voltages to the contact electrode and the separation electrode to increase the oxygen concentration in the metal oxide and increase the concentration of the oxygen vacancies when the oxygen species adsorbed on the metal oxide promote the chemical reaction, and the oxygen concentration in the metal oxide is capable to be reconfigured.

In the method of driving the gas sensor using the metal oxide as the catalyst for the chemical reaction according to the third aspect of the present invention, it is preferable that the method may further include the steps of: (c) applying voltages to the contact and the separation electrodes to reduce the oxygen concentration in the metal oxide and increase the concentration of the oxygen vacancies when oxygen vacancies are consumed by the chemical reaction, thereby restoring the concentration of the oxygen vacancies consumed by the chemical reaction; and (d) applying voltages to the contact electrode and the separation electrode to increase the oxygen concentration in the metal oxide and increase the concentration of the oxygen species adsorbed on the metal oxide when oxygen species adsorbed on the metal oxide are consumed by the chemical reaction, thereby restoring the concentration of the adsorbed oxygen species consumed by the chemical reaction.

In the method of driving the gas sensor using the metal oxide as the catalyst for the chemical reaction according to the third aspect of the present invention, it is preferable that the method may further include the step of (e) supplying energy to the metal oxide using an energy source during the chemical reaction, so that the adjustment of the oxygen concentration in the metal oxide is capable to be promoted.

The method of reconfiguring the oxygen concentration of a metal oxide according to the present invention is capable to generate a potential difference between the separation electrode and the contact electrode based on a predetermined oxygen reconfiguration voltage in advance. The generated potential difference can change the electron concentration in the metal oxide, and as a result, the oxygen concentration on the surface, bulk, grain boundary, etc. of the metal oxide can be adjusted. By using the method of reconfiguring oxygen concentration according to the present invention, the characteristics of chemical reactions using oxygen vacancies in metal oxides or oxygen species adsorbed on metal oxides can be improved.

The method of reconfiguring the oxygen concentration of metal oxide according to the present invention is applicable to devices with various structures including metal oxide, separation electrode, and contact electrode.

In order to control the chemical reaction characteristics of metal oxides, conventional technologies use various manufacturing methods to make different materials constituting metal oxides. However, the methods according to the present invention can manipulate or improve the reactivity to chemical reactions by reconfiguring the oxygen content on the metal oxide using oxygen in the air using the electrical method, even if the same metal oxide is used.

Additionally, the method of reconfiguring the oxygen concentration of a metal oxide according to the present invention can improve selectivity for oxidation or reduction reactions by manipulating the oxygen concentration or the oxygen content on the metal oxide. That is, when the concentration of oxygen vacancies in the metal oxide is increased by the method according to the present invention, the material adsorbed on the metal oxide becomes easy to reduce. On the contrary, when the concentration of oxygen species adsorbed on the metal oxide is increased by the method according to the present invention, the material adsorbed on the metal oxide becomes easy to oxidation. Therefore, by manipulating the oxygen concentration or content on the metal oxide using the method according to the present invention, selectivity for oxidation and reduction reactions can be improved.

Additionally, the method of reconfiguring the oxygen concentration of a metal oxide according to the present invention allows for the manipulation of a chemical reaction in which oxidation and reduction reactions can occur simultaneously, by making one of the reactions dominant while suppressing the other.

Additionally, the method of reconfiguring the oxygen concentration in the metal oxide according to the present invention may apply an oxygen concentration recovery voltage determined in advance after the oxygen concentration in the metal oxide is changed by the chemical reaction. Accordingly, the method according to the present invention can restore the oxygen concentration in the metal oxide by using oxygen in the air to the state before the chemical reaction.

As such, the method of reconfiguring the oxygen concentration in the metal oxide according to the present invention can manipulate the oxygen composition ratio of the metal oxide by repeatedly performing the oxygen concentration reconfiguration process and the oxygen concentration recovery process for the metal oxide. As a result, the method according to the present invention can provide excellent reliability for chemical reactions.

Furthermore, the method according to the present invention ensures that the characteristics of the metal oxide do not change due to chemical reactions, allowing the metal oxide to maintain uniform properties over an extended period.

### BRIEF DESCRIPTION OF THE DRAWINGS

FIGS. 1A and 1B are cross-sectional views showing examples of devices to which the method of reconfiguring the oxygen concentration of metal oxide according to a preferred embodiment of the present invention is applied.

FIGS. 2A and 2B are cross-sectional views showing other examples of devices to which the method of reconfiguring the oxygen concentration of metal oxide according to the preferred embodiment of the present invention is applied.

FIGS. 3A and 3B are cross-sectional views showing other examples of devices to which the method of reconfiguring the oxygen concentration of metal oxide according to the preferred embodiment of the present invention is applied.

FIG. 4 is a cross-sectional view showing another example of a device to which the method of reconfiguring the oxygen concentration of metal oxide according to the preferred embodiment of the present invention is applied.

FIGS. 5A to 5F are graphs illustrating preferred driving methods for the device shown in FIG. 4.

FIG. 6 shows the surface states according to manipulation of the oxygen concentration on indium oxide in the method of reconfiguring the oxygen concentration of metal oxide according to the preferred embodiment of the present invention, where (a) represents a pristine state, (b) represents an O-rich state, and (c) represents an O-deficient state.

FIGS. 7A and 7B are XPS (X-ray Photoelectron Spectroscopy) spectra when the oxygen concentration of indium oxide is manipulated according to the preferred embodiment of the present invention, where FIG. 7A represents the O 1s XPS spectrum, and FIG. 7B represents the In 3d XPS spectrum.

FIG. 8 shows a graph showing the oxygen adsorption energy ΔE obtained through DFT (Density Functional Theory) simulation when adjusting the electron concentration of indium oxide in the method of reconfiguring the oxygen concentration in the metal oxide according to the preferred embodiment of the present invention.

FIGS. 9A and 9B show graphs showing the binding energy ΔE of the nitrogen dioxide NO₂ and hydrogen sulfide H₂S and the charge transfer value ΔQ from the indium oxide to the adsorbed gas obtained by DFT simulation when the oxygen concentration of indium oxide is manipulated in the method of reconfiguring the oxygen concentration of metal oxide according to the preferred embodiment of the present invention.

FIG. 10 is a graph showing resistances when the oxygen concentration of indium oxide, tin oxide, and indium-gallium-zinc oxide are manipulated in the method of reconfiguring the oxygen concentration of metal oxide according to the preferred embodiment of the present invention.

FIGS. 11A, 11B, and 11C show graphs showing the sensitivities of gas sensors for nitrogen dioxide (NO₂), nitrogen monoxide (NO), ammonia (NH₃), hydrogen sulfide (H₂S), or carbon monoxide (CO) depending on the oxygen concentration, respectively, in the method of reconfiguring the oxygen concentration of metal oxide according to the preferred embodiment of the present invention. FIG. 11A represents a graph showing the sensitivity for a gas sensor including indium oxide, FIG. 11B represents a graph showing the sensitivity for a gas sensor including tin oxide, and FIG. 11C represents a graph showing the sensitivity for a gas sensor including indium-gallium-zinc oxide.

FIG. 12 is a graph showing the sensitivities of a gas sensor containing indium oxide to NO₂ and H₂S gas over a long period of time in the method of reconfiguring the oxygen concentration of metal oxide according to the preferred embodiment of the present invention, for comparing the long-term reliability of the gas sensor by using a gas line heating method according to the representative conventional technology and the oxygen concentration reconfiguration method according to the present invention.

FIGS. 13A, 13B and 13C are graphs showing the performance of a gas sensor according to the conventional technology. FIG. 13A represents a graph showing a method of predicting NO₂ gas concentration in a conventional gas sensor. FIG. 13B represents a graph showing the sensor signal of the conventional gas sensor when exposed to rapidly changing NO₂ gas concentrations. FIG. 13C represents a graph showing the sensitivities for various NO₂ gas concentrations in the conventional gas sensor.

FIGS. 14A, 14B and 14C are graphs showing the performance of a gas sensor applying the method of reconfiguring oxygen concentration according to the preferred embodiment of the present invention. FIG. 14A is a graph showing the transient response of the gas sensor to which the oxygen desorption method according to the present invention before the gas reaction is applied when the gas sensor detects NO₂ gas. FIG. 14B is a graph showing the transient response of the gas sensor to which the oxygen desorption method according to the present invention is applied when the gas sensor exposes to various concentrations of NO₂ gas.

FIG. 14C is a graph showing the current change slope (ΔI/Δt) signal with respect to gas concentration when the gas sensor to which the oxygen desorption method according to the present invention was applied before the gas reaction reacts to NO₂ gas.

FIG. 15 is a graph showing the steady-state responses to mixture of gas in a gas sensor using a conventional method in mixed gas environment.

FIGS. 16A and 16B are graphs showing the performances of a gas sensor applying the method of reconfiguring oxygen concentration according to the preferred embodiment of the present invention. FIG. 16A represents a graph showing the transient responses in mixed gas environment when the oxygen desorption method according to the present invention is applied to indium oxide. FIG. 16B represents a graph showing ΔI/Δt signals in the mixed gas environment with various combinations of NO₂ and H₂S gases and a graph showing ΔI/Δt signals versus NO₂ and H₂S gases concentrations in the mixed gas environment with various combinations of NO₂ and H₂S gases.

### DETAILED DESCRIPTION

### First Embodiment

Hereinafter, a method of reconfiguring the oxygen concentration of a metal oxide according to the first embodiment of the present invention will be described in detail with reference to the attached drawings.

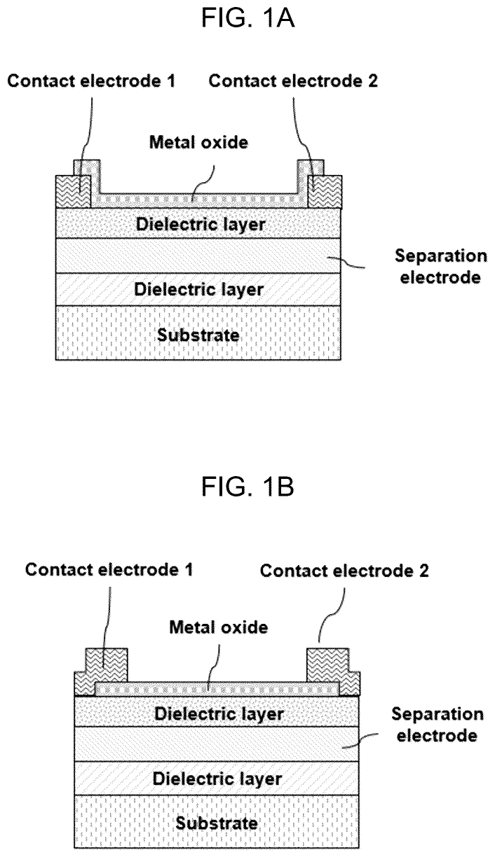

First, device structures to which the method of reconfiguring the oxygen concentration of metal oxide according to the first embodiment of the present invention can be applied will be described. FIGS. 1, 2, and 3 are cross-sectional views exemplarily showing devices to which the method of reconfiguring the oxygen concentration of metal oxide according to the first embodiment of the present invention is applied.

The devices shown in FIG. 1 have a metal oxide, two contact electrodes, and one separation electrode. The device of FIG. 1A has metal oxide positioned on the contact electrodes. The device of FIG. 1B has metal oxide positioned below the contact electrodes.

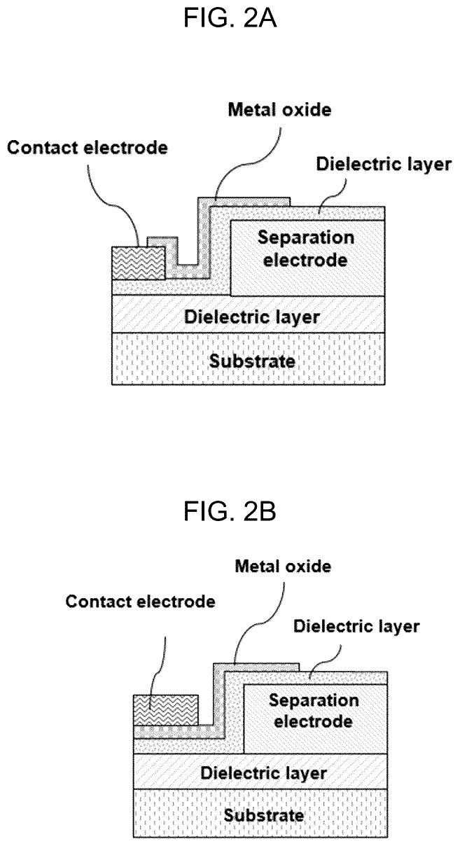

The devices shown in FIG. 2 are devices with a metal oxide, one contact electrode, and one separation electrode. In the device of FIG. 2A, a metal oxide is located above the contact electrode, and in the device of FIG. 2B, a metal oxide is located below the contact electrode.

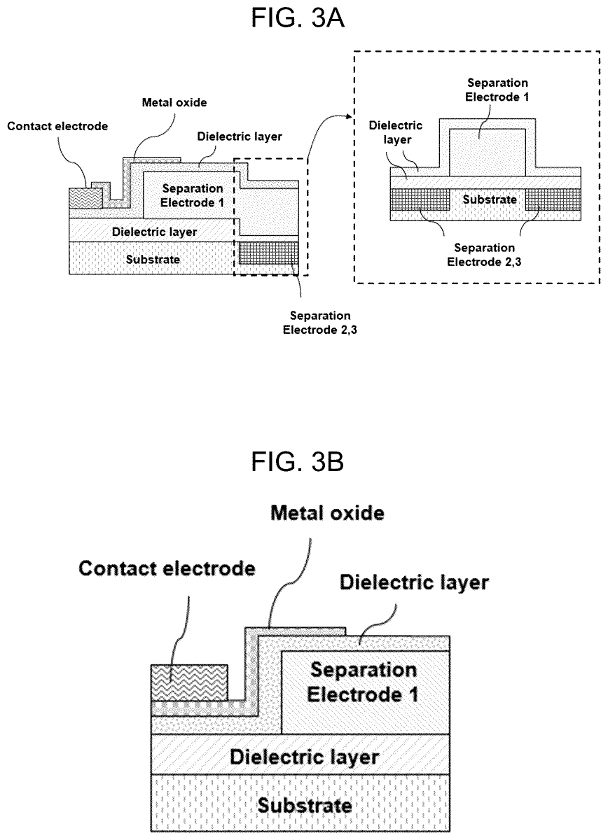

The devices shown in FIG. 3 are devices having a metal oxide, one contact electrode, and two or more separation electrodes. In the devices of FIG. 3, the voltage of the separation electrodes is coupled to each other, so that the voltage of the other separation electrode is adjusted by manipulating the voltage of one separation electrode. Accordingly, the devices in FIG. 3 are configured to manipulate the voltage of the separation electrode facing the contact electrode with the metal oxide in between. In the device of FIG. 3A, the metal oxide is located above the contact electrode, and in the device of FIG. 3B, the metal oxide is located below the contact electrode. And, in FIGS. 3A and 3B, the partial enlarged view shows the relationship between the first separation electrode and the second and third separation electrodes of the corresponding device.

Referring to FIGS. 1, 2, and 3, devices to which the method of reconfiguring the oxygen concentration of a metal oxide according to the present invention can be applied may include a metal oxide, a separation electrode, and a contact electrode, and may further include a dielectric layer and a substrate. The contact electrode may be disposed to be electrically connected to one side or opposite sides of the metal oxide. The separation electrode may be disposed to be electrically spaced apart from the metal oxide with an insulator in between. Additionally, the contact electrode and the separation electrode may be arranged to be electrically spaced apart from each other with an insulator in between. Then, an electric field can be formed in the metal oxide by the voltages applied to the contact electrode and the separation electrode.

In the above-described devices, when the voltage of the contact electrode is higher than the voltage of the separation electrode, the electron concentration in the metal oxide decreases, and when the voltage of the separation electrode is higher than the voltage of the contact electrode, the electron concentration in the metal oxide increases. Therefore, by applying voltage to the contact electrode and the separation electrode to generate a potential difference between the contact electrode and the separation electrode, the electron concentration in the metal oxide can be changed.

Hereinafter, a method of reconfiguring the oxygen concentration of metal oxide according to the first embodiment of the present invention will be described in detail.

In the method of reconfiguring the oxygen concentration in the metal oxide according to the first embodiment of the present invention, first, an oxygen reconfiguration voltage may be determined in advance based on the chemical reaction to be carried out in the metal oxide at step 100. Here, the chemical reaction can be characterized as a reaction using oxygen vacancies of the metal oxide or oxygen species adsorbed on the metal oxide. The oxygen reconfiguration voltage is a voltage that causes the metal oxide to have the electron concentration or the oxygen adsorption or desorption energy required for the chemical reaction.

At the aforementioned step 100, in case that the chemical reaction to be promoted utilizes oxygen vacancies, a first oxygen reconfiguration voltage is determined such that the voltage of the contact electrode is greater than the voltage of the separation electrode, in order to increase the concentration of oxygen vacancies in the metal oxide.

At the aforementioned step 100, in case that the chemical reaction to be promoted utilizes oxygen species adsorbed on the metal oxide, a second oxygen reconfiguration voltage is determined in advance such that the voltage of the separation electrode is greater than the voltage of the contact electrode, in order to increase the concentration of oxygen species adsorbed on the metal oxide.

At the aforementioned step 100, in case that the chemical reaction to be inhibited utilizes oxygen vacancies, a third oxygen reconfiguration voltage is determined in advance such that the voltage of the separation electrode is greater than the voltage of the contact electrode, in order to decrease the concentration of oxygen vacancies in the metal oxide.

At the aforementioned step 100, in case that the chemical reaction to be inhibited uses adsorbed oxygen species, a fourth oxygen reconfiguration voltage is determined in advance such that the voltage of the contact electrode is greater than the voltage of the separation electrode, in order to decrease the concentration of the oxygen species adsorbed on the metal oxide.

Next, before proceeding with the chemical reaction, voltages are applied to the contact electrode and the separation electrode so that the potential difference between the contact electrode and the separation electrode is the determined oxygen reconfiguration voltage at step 110. Through the above-described process, in the method of reconfiguring oxygen concentration according to the present invention, a potential difference occurs between the contact electrode and the separation electrode before proceeding with the chemical reaction. As a result, it can manipulate the electron concentration in the metal oxide and can adjust the oxygen adsorption or desorption energy of the metal oxide, thereby reconfiguring the concentration of oxygen adsorbed on the metal oxide.

In the method of reconfiguring the oxygen concentration in the metal oxide according to the first embodiment of the present invention, the oxygen concentration recovery voltage is determined in advance based on the type of chemical reaction that occurred in the metal oxide, in order to restore the oxygen concentration in the metal oxide to the state before the chemical reaction after the chemical reaction is completed at step 120. The oxygen concentration recovery voltage is a voltage for replenishing oxygen consumed in the metal oxide by the completed chemical reaction.

Next, after the chemical reaction is completed, voltages are applied between the contact electrode and the separation electrode so that the potential difference between the contact electrode and the separation electrode becomes the oxygen concentration recovery voltage at step 130. The method of reconfiguring the oxygen concentration according to the present invention can restore the oxygen concentration in the metal oxide to the state before the chemical reaction by the above-described steps 120 and 130 even if the oxygen concentration in the metal oxide is reduced or increased by the chemical reaction.

At the aforementioned step 120, in case that the oxygen vacancy concentration in the metal oxide has decreased due to the chemical reaction, it is preferable to determine a first oxygen concentration recovery voltage such that the voltage of the contact electrode is greater than the voltage of the separation electrode, in order to increase the concentration of oxygen vacancy in the metal oxide.

At the aforementioned step 120, in case that the concentration of oxygen species adsorbed on the metal oxide has decreased due to the chemical reaction, it is preferable to determine the second oxygen concentration recovery voltage such that the voltage of the separation electrode is greater than the voltage of the contact electrode, in order to increase the concentration of oxygen species adsorbed on the metal oxide.

Meanwhile, in the method of reconfiguring the oxygen concentration in the metal oxide according to the present invention, it is preferable to promote the adjustment of the oxygen concentration in the metal oxide by supplying energy to the metal oxide using an energy source during the chemical reaction. The energy source can be a heat source such as a heater or a light source. In this way, while changing the electron concentration in the metal oxide, if the energy of the metal oxide is increased using the energy source, the oxygen concentration in the metal oxide can be adjusted quickly.

As described above, in the method of reconfiguring the oxygen concentration in the metal oxide according to the present invention, the electron concentration in the metal oxide needs to be increased to increase the oxygen concentration in the metal oxide, and the electron concentration in the metal oxide needs to be decreased to reduce the oxygen concentration in the metal oxide. Therefore, in the present invention, the method for reconfiguring the oxygen concentration in the metal oxide can be implemented by changing the electron concentration in the metal oxide using the voltage difference between the contact electrode and the separation electrode.

When a potential difference between the contact electrode and the separation electrode of the device is generated by applying voltages to the contact electrode and the separation electrode of the device, respectively, the electron concentration in the metal oxide changes. This change in the electron concentration of the metal oxide alters the oxygen adsorption or desorption energy of the metal oxide. As a result, oxygen in the air may be adsorbed onto the metal oxide or oxygen adsorbed onto the metal oxide may be desorbed, thereby changing the oxygen concentration in the metal oxide.

Therefore, the method of reconfiguring the oxygen concentration in the metal oxide according to the present invention can increase the electron concentration in the metal oxide and the oxygen concentration in the metal oxide by making the voltage of the separation electrode higher than that of the contact electrode. In addition, the method of reconfiguring the oxygen concentration in the metal oxide according to the present invention can decrease the electron concentration in the metal oxide and thereby decrease the oxygen concentration in the metal oxide by making the voltage of the contact electrode higher than that of the separation electrode.

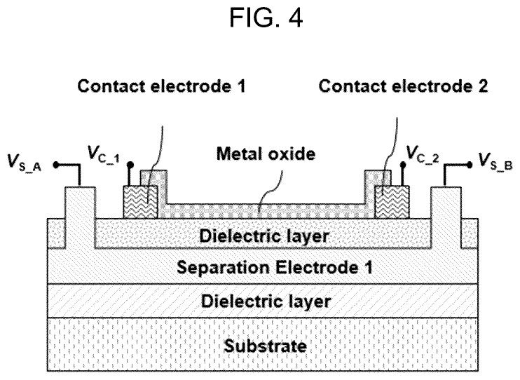

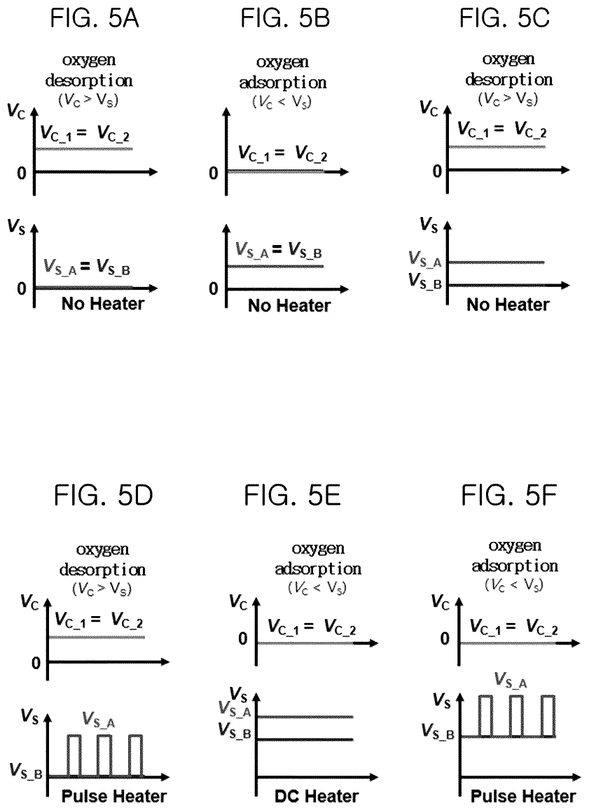

FIG. 4 is a cross-sectional view showing an example of a device to which the method of reconfiguring the oxygen concentration in metal oxide according to the first preferred embodiment of the present invention is applied. The device shown in FIG. 4 is characterized in that the separation electrode operates as a heater, which is a heat source. FIGS. 5A to 5F are graphs illustrating preferred driving methods for the device shown in FIG. 4.

Referring to FIGS. 4 and 5, the device shown in FIG. 4 uses self-heating (Joule heating) generated in the separation electrode as the heat source when a voltage is applied to the separation electrode. As shown in FIGS. 5A to 5F, the voltage applied to the separation electrode may be formed in DC or pulse form. The device shown in FIG. 4 uses a separation electrode as a heat source and can control the oxygen concentration in the metal oxide by using the potential difference between the separation electrode and the contact electrode.

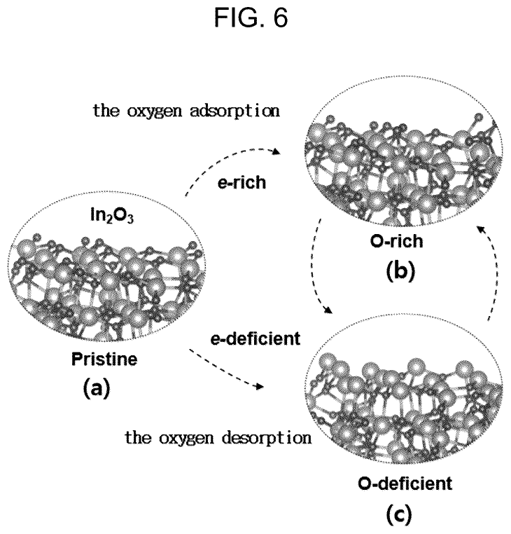

FIG. 6 shows the surface state of indium oxide (In₂O₃) when the method of reconfiguring the oxygen concentration in metal oxide according to the first embodiment of the invention is applied to indium oxide. In FIG. 6, (a) represents the Pristine state before reconfigure the oxygen concentration, (b) represents the O-rich state where the oxygen concentration is increased, and (c) represents the O-deficient state where the oxygen concentration is decreased.

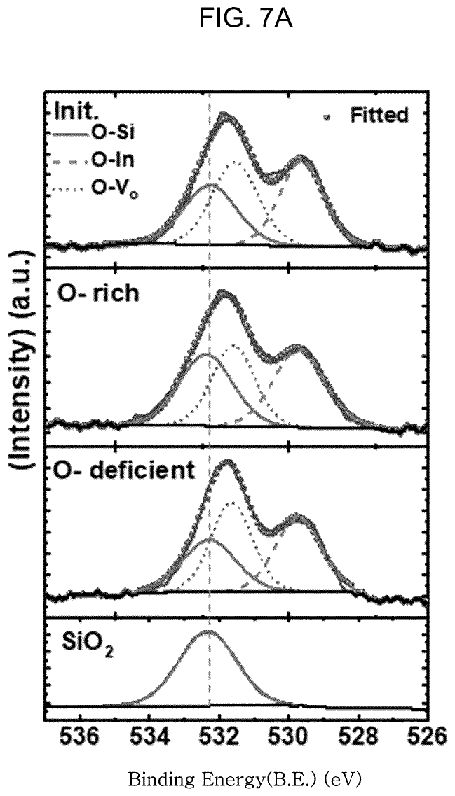

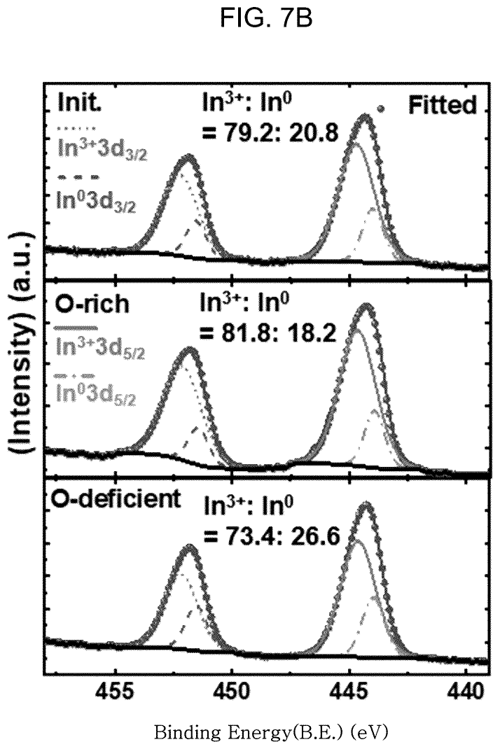

FIGS. 7A and 7B are XPS (X-ray photoelectron spectroscopy) spectrums when the oxygen concentration is manipulated by applying the method of reconfiguring the oxygen concentration in the metal oxide according to the first embodiment of the invention to indium oxide. FIG. 7A represents the O 1s XPS spectrum, and FIG. 7B represents the In 3d XPS spectrum. Referring to FIGS. 7A and 7B, it can be seen that when oxygen desorption is proceeded, the lattice oxygen concentration decreases and the concentration of metal atoms perfectly bonded to oxygen decreases. Meanwhile, when oxygen adsorption is proceeded, it can be seen that the lattice oxygen concentration increases and the concentration of metal atoms perfectly bonded to oxygen increases.

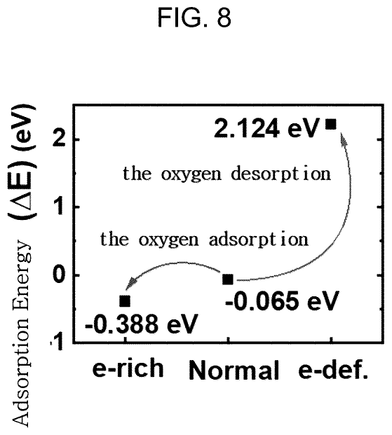

FIG. 8 is a graph showing oxygen adsorption energy (ΔE) obtained through DFT (Density Functional Theory) simulation when the method of reconfiguring the oxygen concentration in the metal oxide according to the first embodiment of the present invention is applied to indium oxide to manipulate the electron concentration in the indium oxide. Referring to FIG. 8, the oxygen adsorption energies (ΔE) can be seen for the e-rich state (high electron concentration), the normal state (regular electron concentration), and the e-deficient state (low electron concentration). As the electron concentration increases, the oxygen adsorption energy increases in the negative direction, resulting in better adsorption. Conversely, when the electron concentration decreases, the oxygen adsorption energy increases in the positive direction, resulting in better desorption. Consequently, the concentration of oxygen adsorbed on the indium oxide changes.

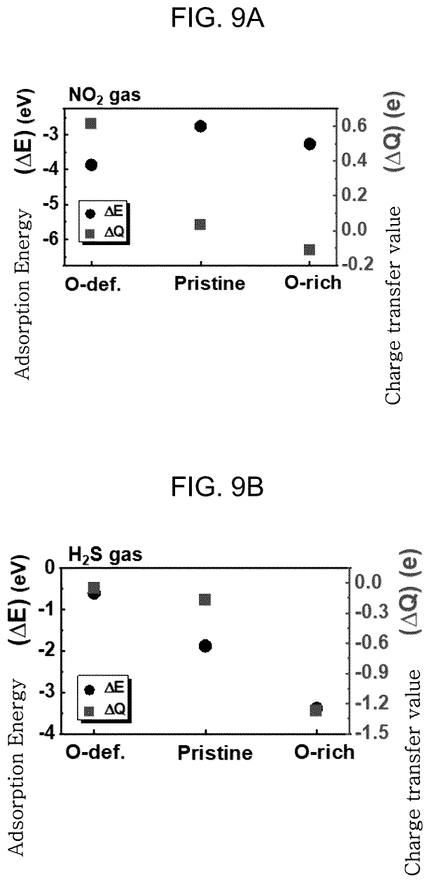

FIG. 9A is a graph showing the adsorption energy (ΔE) of nitrogen dioxide gas (NO₂) and the amount of charge transfer (ΔQ) from indium oxide (In₂O₃) to the adsorbed gas obtained through DFT simulation when the oxygen concentration of indium oxide (In₂O₃) is adjusted according to the method of reconfiguring the oxygen concentration in the metal oxide according to the first embodiment of the present invention. FIG. 9B is a graph showing the adsorption energy (ΔE) of hydrogen sulfide gas (H₂S) and the amount of charge transfer (ΔQ) from indium oxide (In₂O₃) to the adsorbed gas obtained through DFT simulation when the oxygen concentration of indium oxide (In₂O₃) is adjusted according to the method of reconfiguring the oxygen concentration in the metal oxide according to the first embodiment of the present invention.

NO₂ is a representative oxidizing gas that captures electrons from the metal oxide. When the amount of oxygen adsorbed on the metal oxide is low, the adsorption energy of NO₂ has a large negative value, and the charge transfer from the metal oxide to NO₂ is significant. On the other hand, H₂S is a representative reducing gas that reacts with the oxygen species adsorbed on the metal oxide and provides electrons to the metal oxide. When the amount of oxygen adsorbed on the metal oxide is high, the adsorption energy of H₂S has a large negative value, and the charge transfer from the metal oxide to H₂S is significant.

Referring to FIG. 9, it can be seen that when the oxygen concentration is low and the concentration of oxygen vacancies is high, a reaction in which electrons move from the metal oxide to the adsorbed material and the adsorbed material is reduced occurs easily. Conversely, when the oxygen concentration is high and the concentration of oxygen species adsorbed on the metal oxide is high, it can be seen that a reaction in which electrons move from the adsorbed material to the metal oxide and the adsorbed material is oxidized easily occurs.

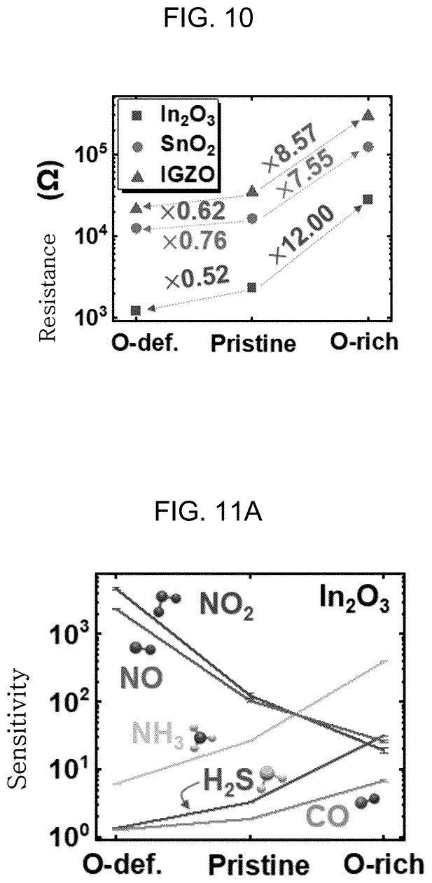

FIG. 10 is a graph showing resistances when the oxygen concentrations of indium oxide, tin oxide, and indium-gallium-zinc oxide are adjusted in the method of reconfiguring the concentration of metal oxide according to the first embodiment of the present invention. Among metal oxides, indium oxide, tin oxide, and indium-gallium-zinc oxide are n-type semiconductors. For n-type semiconductors, when oxygen which is an oxidizing gas is adsorbed, electrons are taken away to increase the resistance, and when oxygen is desorbed, the electron concentration increases to decrease the resistance. Conversely, for p-type semiconductors, when oxygen is adsorbed, the resistance decreases, and when oxygen is desorbed, the resistance increases.

In both n-type and p-type semiconductor metal oxides, increasing the electron concentration in the metal oxide leads to an increase in the oxygen concentration of the metal oxide, while decreasing the electron concentration leads to a decrease in the oxygen concentration of the metal oxide. Referring to FIG. 10, it can be seen that the method of reconfiguring the oxygen concentration of metal oxides according to the present invention can adjust the oxygen concentration in various metal oxides.

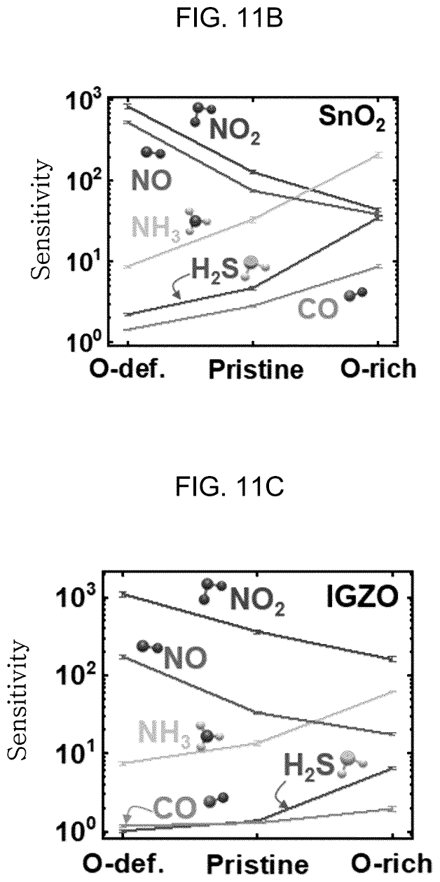

Referring to FIG. 11, it can be seen that for the aforementioned three types of metal oxides, as the oxygen concentration decreases, the reactions between the metal oxide and the oxidizing gases increase, resulting in higher sensitivity to oxidizing gases. Here, the oxidizing gases are NO and NO₂. Additionally, referring to FIG. 11, it can be seen that for the three types of metal oxides described above, as the oxygen concentration increases, the reactions between the metal oxide and the reducing gases increase, resulting in higher sensitivity to reducing gases. Here, the reducing gases are NH₃, H₂S, and CO.

Referring to FIG. 11, the method of reconfiguring the oxygen concentration in the metal oxide according to the present invention can promote a specific type of reaction depending on the direction of adjustment of oxygen content on metal oxide. When the oxygen concentration in the metal oxide increases, the reaction between the oxidizing agent and the metal oxide is weakened, while the reaction between the reducing agents and the metal oxide is strengthened. Conversely, when the oxygen concentration in the metal oxide decreases, the reaction between the oxidizing agents and the metal oxide is strengthened, while the reaction between the reducing agents and the metal oxide is weakened.

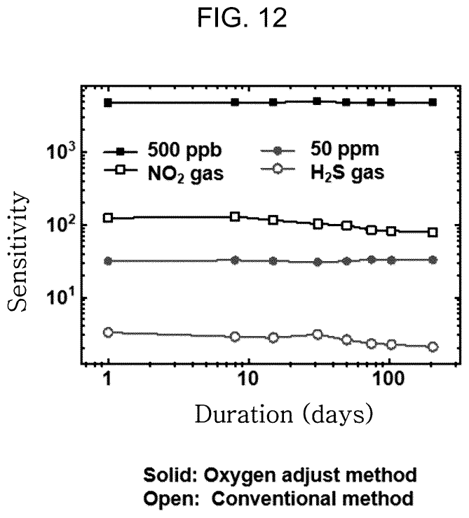

FIG. 12 is a graph showing the sensitivities to NO₂ and H₂S gases over a long period for a gas sensor containing indium oxide, according to the first embodiment of the present invention. Through FIG. 12, the long-term reliability of gas sensors using the conventional typical gas line heating method and the oxygen concentration control method of the present invention can be compared. Referring to FIG. 12, when the method of the present invention is used to control the oxygen concentration of the metal oxide, the oxygen concentration of the metal oxide can be maintained consistently regardless of the gas reaction and the passage of time. As a result, uniform gas reactivity can be obtained. Therefore, compared to the conventional gas line heating method, where the metal oxide is heated before the gas reaction, the method according to the present invention ensures excellent reliability in the long-term operation of the sensor.

### Second Embodiment

Hereinafter, a method of driving a gas sensor according to a second embodiment of the present invention will be described in detail. The second embodiment of the present invention is characterized by applying the method of reconfiguring the oxygen concentration in the metal oxide according to the first embodiment to a gas sensor. The gas sensor includes a metal oxide, a contact electrode in contact with the metal oxide, and a separation electrode electrically separated from the metal oxide.

In the method of driving the gas sensor according to this embodiment, before the gas sensor proceeds with the gas detection reaction, an oxygen reconfiguration voltage for reconfiguring the oxygen concentration in the metal oxide according to the target gas is predetermined at step 200. Here, the target gas refers to the gas that the gas sensor aims to detect.

In the above-described step 200, in case that the target gas is an oxidizing gas, a first oxygen reconfiguration voltage is predetermined such that the voltage of the contact electrode is higher than the voltage of the separation electrode in order to lower the oxygen concentration in the metal oxide and increase the concentration of oxygen vacancies. In the above-described step 200, in case that the target gas is a reducing gas, a second oxygen reconfiguration voltage is predetermined such that the voltage of the contact electrode is lower than the voltage of the separation electrode in order to increase the oxygen concentration in the metal oxide and increase the concentration of oxygen species adsorbed on the metal oxide. In the above-described step 200, in case that the target gas is a mixture of oxidizing and reducing gases, a third oxygen reconfiguration voltage for detecting the oxidizing gas and a fourth oxygen reconfiguration voltage for detecting the reducing gas are predetermined.

Next, in the method of driving a gas sensor according to this embodiment, voltages are applied to the contact electrode and the separation electrode, respectively, so that the potential difference between the contact electrode and the separation electrode is the oxygen reconfiguration voltage at step 210. By the above-described process, the electron concentration in the metal oxide can be manipulated and the oxygen adsorption or desorption energy of the metal oxide can be adjusted, thereby reconfiguring the oxygen concentration adsorbed on the metal oxide. The sensing reaction of the gas sensor is characterized in that it is a reaction using oxygen vacancies in the metal oxide or oxygen species adsorbed on the metal oxide.

In the above-described step 210, when the target gas is an oxidizing gas, voltages are applied to the contact electrode and the separation electrode such that the potential difference between the contact electrode and the separation electrode becomes the first oxygen reconfiguration voltage. Consequently, the voltage of the contact electrode becomes higher than that of the separation electrode. As a result, the oxygen concentration in the metal oxide can decrease and the concentration of oxygen vacancies can increase.

In the above-described step 210, when the target gas is a reducing gas, voltages are applied to the contact electrode and the separation electrode such that the potential difference between the contact electrode and the separation electrode becomes the second oxygen reconfiguration voltage. Consequently, the voltage of the contact electrode becomes lower than that of the separation electrode. As a result, the oxygen concentration in the metal oxide can increase and the concentration of oxygen species adsorbed on the metal oxide can increase.

In the aforementioned step 210, if the target gas is a mixture of oxidizing and reducing gases, voltages are applied to the contact electrode and the separation electrode such that the potential difference between the contact electrode and the separation electrode initially becomes the third oxygen reconfiguration voltage. Consequently, the voltage of the contact electrode becomes higher than that of the separation electrode. As a result, the oxygen concentration in the metal oxide can decrease and the concentration of oxygen vacancies can increase, which allows for the primary detection of the oxidizing gas. After the primary detection of the oxidizing gas, voltages are applied to the contact electrode and the separation electrode such that the potential difference between the contact electrode and the separation electrode becomes the fourth oxygen reconfiguration voltage. Consequently, the voltage of the contact electrode becomes lower than that of the separation electrode. As a result, the oxygen concentration in the metal oxide increases and the concentration of oxygen species adsorbed on the metal oxide increases, which allows for the secondary detection of the reducing gas.

Meanwhile, in the method of driving the gas sensor according to this embodiment, after the gas detection reaction is completed, an oxygen concentration recovery voltage for the target gas of the gas sensor is predetermined to restore the oxygen concentration of the metal oxide to its state before the detection reaction at step 220.

In the aforementioned step 220, in case that the target gas of the gas sensor is an oxidizing gas, a first oxygen concentration recovery voltage is predetermined such that the voltage of the contact electrode is higher than that of the separation electrode to decrease the oxygen concentration of the metal oxide and increase the concentration of oxygen vacancies.

In the aforementioned step 220, in case that the target gas of the gas sensor is a reducing gas, a second oxygen concentration recovery voltage is predetermined such that the voltage of the contact electrode is lower than that of the separation electrode to increase the oxygen concentration of the metal oxide and the concentration of adsorbed oxygen species

Next, after the gas sensing reaction is completed, voltages are applied to the contact electrode and the separation electrode, respectively, so that the potential difference between the contact electrode and the separation electrode becomes the oxygen concentration recovery voltage at step 230. As a result, the metal oxide of the gas sensor can restore the oxygen concentration consumed by the sensing reaction to the state before the sensing reaction.

Meanwhile, in the method of driving a gas sensor according to this embodiment, it is preferable to further include a step of supplying energy to the metal oxide using an energy source while the process of manipulating the oxygen concentration in the metal oxide is in progress. By supplying energy to the metal oxide, the adjustment of the oxygen concentration in the metal oxide can be promoted.

Meanwhile, the driving method of the gas sensor according to the second embodiment of the present invention can also be applied to an array structure in which a plurality of gas sensors is arranged. In this case, oxygen reconfiguration voltages for the gas sensors in the gas sensor array are predetermined, respectively. The oxygen reconfiguration voltages for each gas sensor can be predetermined differently from one another. Then, the voltages are applied to the contact electrode and the separation electrode of each gas sensor based on the oxygen reconfiguration voltages predetermined for each gas sensor. This allows the metal oxides of each gas sensor in the gas sensor array to have different oxygen concentrations.

Therefore, by applying the driving method of the gas sensor according to the present invention to the gas sensor array, the oxygen concentrations of the metal oxides of each gas sensor can be manipulated differently. As a result, metal oxides with different oxygen concentrations can detect the same target gas. Consequently, the gas sensor array according to the present invention can improve the accuracy of detection and measurement of the target gas.

In addition, the driving method of the gas sensor according to the second embodiment of the present invention generates a potential difference between the contact electrode and the separation electrode during the gas reaction process, which in turn alters the electron concentration of the metal oxide. As a result, the gas adsorption or desorption energy of the metal oxide is adjusted, thereby enhancing the gas reaction characteristics of the gas sensor.

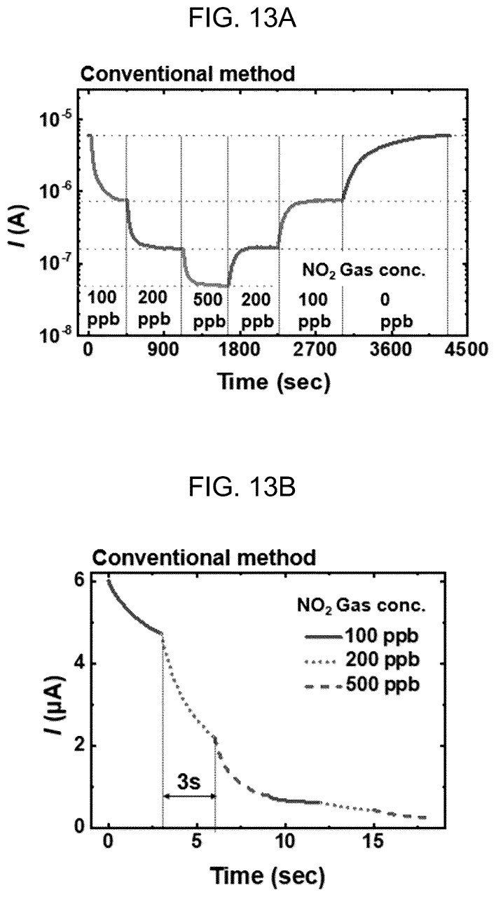

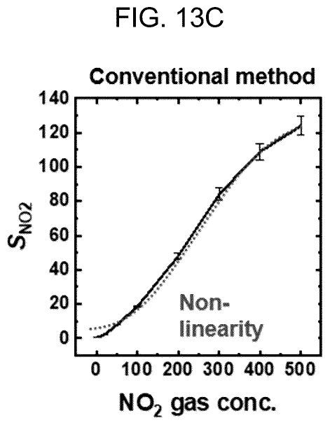

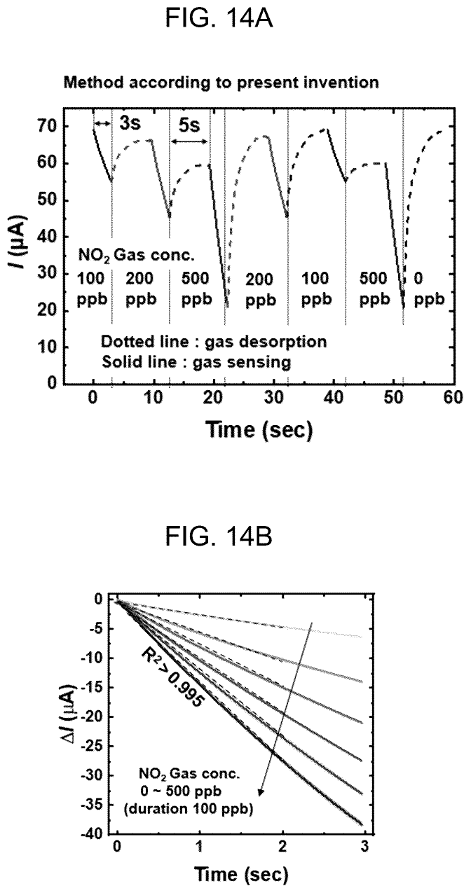

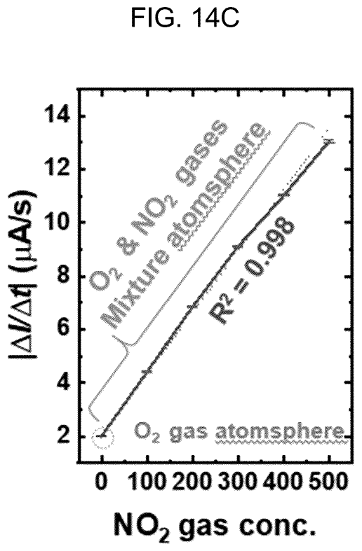

FIGS. 13 and 14 are graphs illustrating the performance of a gas sensor using a conventional method and the performance of a gas sensor applying a method of reconfiguring oxygen concentration according to the first embodiment, respectively. FIG. 13 is a graph illustrating the performance of a gas sensor applying a conventional method, and FIG. 14 is a graph illustrating the performance of a gas sensor applying a method according to the present invention.

FIG. 13A is a graph illustrating the performance of a conventional gas sensor using a method to predict NO₂ gas concentration. Referring to FIG. 13A, it can be seen that conventional gas sensors carry out the gas reaction until the sensor signal reaches a steady state, and then use the steady state signal to infer the gas concentration. Therefore, conventional gas sensors have the drawback of requiring a significant amount of time to estimate the gas concentration. FIG. 13B is a graph illustrating a sensor signal when the conventional gas sensor is exposed to a rapidly changing NO₂ gas concentration. Referring to FIG. 13B, it can be seen that the transient response of the conventional gas sensor is significantly influenced by the previous gas exposure history. Therefore, it is impossible to infer and predict the gas concentration using the transient response. FIG. 13C is a graph showing the sensor signals of the conventional gas sensor for various NO₂ gas concentrations. Referring to FIG. 13C, it can be seen that the sensor signal of the conventional gas sensor exhibits nonlinearity with respect to the gas concentration.

Meanwhile, FIG. 14A is a graph showing a transient response of a gas sensor when detecting NO₂ gas, where the oxygen desorption method according to the present invention is applied before the gas reaction. From FIG. 14A, it can be seen that the gas sensor using the method according to the present invention exhibits a unique transient response for each gas concentration. Therefore, it is possible to predict the gas concentration using the transient response. FIG. 14B is a graph showing the transient response of a gas sensor, where the oxygen desorption method according to the present invention is applied, when the sensor is repeatedly exposed to varying concentrations of NO₂ gas. From FIG. 14B, it can be observed that the slope of the sensor's transient response is proportional to the gas concentration. FIG. 14C is a graph showing the current change slope (ΔI/Δt) signal in response to NO₂ gas for a gas sensor where the oxygen desorption method according to the present invention is applied before the gas reaction. From FIG. 14C, it can be seen that the response signal of the gas sensor exhibits linearity with respect to the gas concentration.

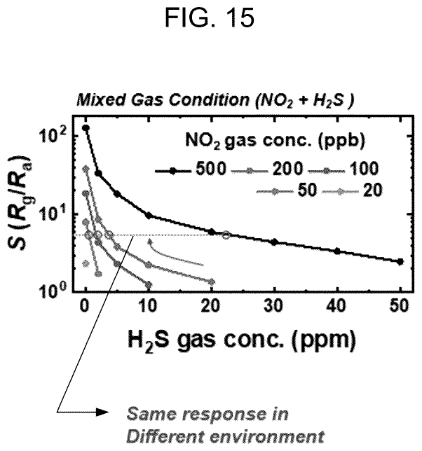

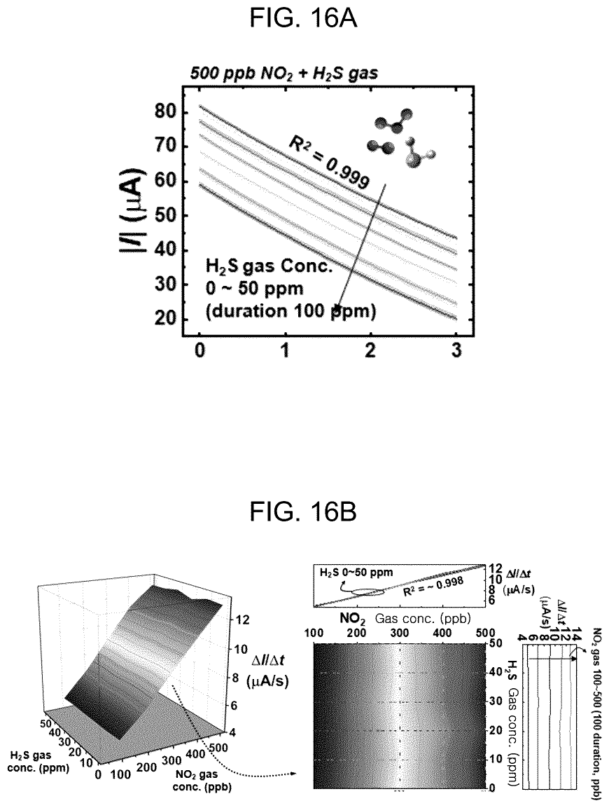

FIGS. 15 and 16 are graphs illustrating comparisons between the performance of a gas sensor using a conventional method and the performance of a gas sensor applying a method of reconfiguring oxygen concentration according to the present invention. FIG. 15 is a graph illustrating the reactivity of a gas sensor applying the conventional method to a gas mixture. FIG. 16 is graphs illustrating the performance of a gas sensor applying the method of reconfiguring oxygen concentration according to the preferred embodiment of the present invention. Referring to FIG. 15, it can be seen that conventional gas sensors exhibit the same reactivity across various combinations of mixed gases, making it difficult to predict gas concentrations in mixed gas scenarios.

FIG. 16A is a graph showing a transient response to the gas mixture when the oxygen desorption method according to the present invention is applied to indium oxide. Referring to FIG. 16A, it can be seen that the gas sensor using the method according to the present invention maintains its slope based on the H₂S gas concentration even if the initial current value changes. FIG. 16B is a graph showing a slope (ΔI/Δt) signal in the transient response of the sensor in environment with mixed NO₂ and H₂S gases. Referring to FIG. 16B, the gas sensor using the method according to the present invention is sensitive to NO₂ gas but not sensitive to H₂S gas, and can provide a signal proportional to the NO₂ gas concentration and independent of the H₂S gas concentration. As a result, the gas sensor using the method of the present invention can accurately predict the NO₂ gas concentration even in the presence of mixed NO₂ and H₂S gases.

### Third Embodiment

Hereinafter, a method of operating a device using a metal oxide as a catalyst according to the third embodiment of the present invention will be specifically described.

The method of reconfiguring the oxygen concentration of a metal oxide according to the first embodiment of the present invention described above can be applied to the oxygen concentration manipulation for changing the characteristics of various chemical reactions in a device using a metal oxide as a catalyst. The signal of a gas sensor is the electrical signal converted from a chemical reaction between a metal oxide and a gas. In addition, the method of reconfiguring the oxygen concentration and the method of operating a gas sensor according to the first and second embodiments of the present invention can be applied in the same manner to the field of heterogeneous catalysts utilizing the reaction between a metal oxide and a gas and the field of energy conversion. The third embodiment of the present invention is characterized in that the method of reconfiguring the oxygen concentration according to the first embodiment is applied to a method of driving a device using a metal oxide as a catalyst. The device includes a metal oxide used as a catalyst, a contact electrode in contact with the metal oxide, and a separation electrode separated from the metal oxide by a dielectric layer.

The driving method of the device according to this embodiment involves reconstructing the oxygen concentration of the metal oxide according to the type of chemical reaction before the reaction proceeds at step 300. In the aforementioned step 300, if oxygen vacancies in the metal oxide facilitate the chemical reaction, the voltage of the contact electrode is raised above the voltage of the separation electrode, thereby lowering the oxygen concentration of the metal oxide and increasing the concentration of oxygen vacancies. In the aforementioned step 300, if the oxygen species adsorbed on the metal oxide facilitate the reaction, the voltage of the contact electrode is lowered below the voltage of the separation electrode, thereby increasing the oxygen concentration of the metal oxide and the concentration of oxygen species adsorbed on the metal oxide. Through the aforementioned step 300, the oxygen concentration of the metal oxide is reconstructed before the chemical reaction proceeds.

Meanwhile, in the driving method of the device according to this embodiment, it is preferable to further include a step of restoring the oxygen concentration of the metal oxide to its pre-reaction state after the chemical reaction has been completed at step 320. In the aforementioned step 320, if oxygen vacancies have been depleted during the chemical reaction, voltages are applied to the contact electrode and the separation electrode such that the voltage of the contact electrode is higher than that of the separation electrode. As a result, the oxygen concentration of the metal oxide is lowered and the concentration of oxygen vacancies is increased, allowing for the restoration of the oxygen vacancies that were consumed during the chemical reaction. In the aforementioned step 320, if the oxygen species adsorbed on the metal oxide have been depleted during the chemical reaction, voltages are applied to the contact electrode and the separation electrode such that the voltage of the contact electrode is lower than that of the separation electrode. As a result, the oxygen concentration of the metal oxide is increased, and the concentration of adsorbed oxygen species is replenished, restoring the concentration of the adsorbed oxygen species consumed during the chemical reaction. Through the aforementioned step 320, the oxygen concentration of the metal oxide can be restored to its pristine state before the chemical reaction, ensuring the device is ready for subsequent reactions.

Meanwhile, in the driving method of the device according to this embodiment, it is preferable to further include a step of supplying energy to the metal oxide using an energy source, such as a heat source or light source, during the chemical reaction. By supplying energy to the metal oxide in this manner while the chemical reaction is in progress, the adjustment of the oxygen concentration in the metal oxide can be facilitated, enhancing the overall efficiency of the reaction.

The driving method of the device using the metal oxide as a catalyst according to the third embodiment can also be applied to an array structure in which a plurality of devices is arranged. In this case, different oxygen reconfiguration voltages are predetermined for each device constituting the array structure, respectively. Then, voltages are applied to the contact electrode and the separation electrode of each device according to the oxygen reconfiguration voltage predetermined differently for each device. As a result, the metal oxide of each device constituting the array structure can have a different oxygen concentration. Therefore, the array structure using the driving method of the device according to the present invention can not only derive various measurement results for the same chemical reaction but also improve accuracy by determining the oxygen concentrations of the metal oxides of each device differently.

In the above, the present invention has been described with respect to the preferred embodiment thereof, but this is only an example and does not limit the present invention. It will be appreciated that various modifications and applications not exemplified above are possible within the scope of the present invention defined in the appended claims. In addition, the differences related to such modifications and applications should be construed as being included in the scope of the present invention defined in the appended claims.

What is claimed is:

1. Method of reconfiguring oxygen concentration of a metal oxide in an electronic device comprising the metal oxide, a contact electrode in contact with the metal oxide, and a separation electrode electrically isolated from the metal oxide, comprising the following steps of:
(a) predetermining an oxygen reconfiguration voltage required to enable the metal oxide to have an electron concentration or oxygen adsorption or desorption energy needed for any given chemical reaction; and
(b) applying voltages to the contact electrode and the separation electrode so that the potential difference between the contact electrode and the separation electrode becomes said oxygen reconfiguration voltage,
wherein the oxygen concentration in the metal oxide is reconfigured by manipulating the electron concentration in the metal oxide or adjusting the oxygen adsorption or desorption energy of the metal oxide, and
wherein said chemical reaction is a reaction utilizing oxygen vacancies in the metal oxide or oxygen species adsorbed on the metal oxide.

2. Method of reconfiguring the oxygen concentration in the metal oxide according to claim 1, wherein the step (a) comprises:
(a1) in case that said chemical reaction to be promoted utilizes oxygen vacancies of the metal oxide, predetermining a first oxygen reconfiguration voltage required to increase the concentration of oxygen vacancies in the metal oxide; and
(a2) in case that said chemical reaction to be promoted utilizes oxygen species adsorbed on the metal oxide, predetermining a second oxygen reconfiguration voltage required to increase the concentration of the oxygen species adsorbed on the metal oxide.

3. Method of reconfiguring the oxygen concentration in the metal oxide according to claim 1, wherein the step (a) comprises:
(a3) in case that said chemical reaction to be suppressed utilizes oxygen vacancies, predetermining a third oxygen reconfiguration voltage required to reduce the concentration of oxygen vacancies in the metal oxide; and
(a4) in case that said chemical reaction to be suppressed utilizes adsorbed oxygen species, predetermining a fourth oxygen reconfiguration voltage required to reduce the concentration of the oxygen species adsorbed on the metal oxide.

4. Method of reconfiguring the oxygen concentration in the metal oxide according to claim 1, further comprising the following steps of:
(c) predetermining an oxygen concentration recovery voltage based on the chemical reaction that has occurred in the metal oxide; and
(d) after said chemical reaction is completed, applying voltages to the contact electrode and the separation electrode such that a potential difference between the contact electrode and the separation electrode becomes said oxygen concentration recovery voltage, and
wherein after the completion of the chemical reaction involving the metal oxide, the oxygen concentration in the metal oxide is restored to the oxygen concentration before the chemical reaction.

5. Method of reconfiguring the oxygen concentration in the metal oxide according to claim 4, wherein the step (c) comprises:
(c1) predetermining a first oxygen concentration recovery voltage required to increase the concentration of oxygen vacancies of the metal oxide when the concentration of oxygen vacancies of the metal oxide is reduced by the chemical reaction; and
(c2) predetermining a second oxygen concentration recovery voltage required to increase the concentration of oxygen species adsorbed on the metal oxide when the concentration of oxygen species adsorbed on the metal oxide is reduced by the chemical reaction.

6. Method of reconfiguring the oxygen concentration in the metal oxide according to claim 1, further comprising the following step of:
(d) supplying energy to the metal oxide utilizing an energy source at least during all or part of manipulation of the oxygen concentration in the metal oxide, in order to promote the process of adjusting the oxygen concentration in the metal oxide.

7. Method of reconfiguring the oxygen concentration in the metal oxide according to claim 1, wherein the method is applied to an array structure in which a plurality of electronic devices is arranged, and
said oxygen reconfiguration voltages of the electronic devices constituting the array structure are determined, respectively.

8. Method of reconfiguring the oxygen concentration in the metal oxide according to claim 1, wherein the method is applied to a device having first and second separation electrodes electrically coupled to each other, and
the voltage of the first separation electrode is manipulated by applying voltage to the second separation electrode of the device so that the potential difference between the first separation electrode and the contact electrode in the device becomes said oxygen reconfiguration voltage.

9. Method of reconfiguring the oxygen concentration in the metal oxide according to claim 1, wherein the method is applied to a device that utilizes a separation electrode as a heat source and generates heat by applying voltage to the separation electrode.

10. A method of driving a gas sensor configured to detect a target gas, including a metal oxide, a contact electrode in contact with the metal oxide, and a separation electrode electrically separated from the metal oxide, comprising the following steps of:
(a) predetermining an oxygen reconfiguration voltage based on the target gas in advance; and
(b) applying voltages to the contact electrode and the separation electrode so that the potential difference between the contact electrode and the separation electrode becomes said oxygen reconfiguration voltage,
wherein the electron concentration in the metal oxide is manipulated and the oxygen adsorption or desorption energy of the metal oxide is adjusted, in order to reconfigure the oxygen concentration adsorbed on the metal oxide, and
the detection reaction of the gas sensor for the target gas is a reaction using oxygen vacancies of the metal oxide or oxygen species adsorbed on the metal oxide.

11. Method of driving the gas sensor according to claim 10, wherein the step (a) comprises:
(a1) in case that the target gas of the gas sensor is an oxidizing gas, predetermining a first oxygen reconfiguration voltage required to reduce the oxygen concentration in the metal oxide and increase the concentration of oxygen vacancies; and
(a2) in case that the target gas of the gas sensor is a reducing gas, predetermining a second oxygen reconfiguration voltage required to increase the oxygen concentration in the metal oxide and increase the concentration of adsorbed oxygen species.

12. Method of driving the gas sensor according to claim 10, wherein further comprising the following steps of;
(c) predetermining an oxygen concentration recovery voltage based on the target gas of the gas sensor; and
(d) applying voltages to the contact electrode and the separation electrode after the detection reaction of the gas sensor is completed, so that the potential difference between the contact electrode and the separation electrode becomes said oxygen concentration recovery voltage, and
wherein the oxygen concentration in the metal oxide of the gas sensor consumed by the detection reaction is recovered to the state before the detection reaction.

13. Method of driving the gas sensor according to claim 10, wherein the step (a) comprises the step of (a3) in case that the target gas of the gas sensor is a mixture of an oxidizing and a reducing gases, predetermining a third oxygen reconfiguration voltage for detecting the oxidizing gas and a fourth oxygen reconfiguration voltage for detecting the reducing gas, and
the step (b) is the step of performing a primary detection of the oxidizing gas using the third oxygen reconfiguration voltage, and after said primary detection of the oxidizing gas, performing a secondary detection of the reducing gas using the fourth oxygen reconfiguration voltage, and
wherein said third oxygen reconfiguration voltage is a voltage required to reduce the oxygen concentration in the metal oxide and increase the concentration of oxygen vacancies, and said fourth oxygen reconfiguration voltage is a voltage required to increase the oxygen concentration in the metal oxide.

14. Method of driving the gas sensor according to claim 10, wherein the method is applied to an array structure in which a plurality of gas sensors is arranged, and
the oxygen reconfiguration voltages of gas sensors constituting the array structure are predetermined, respectively, so that the metal oxides of each gas sensor have different oxygen concentrations.

15. Method of driving the gas sensor according to claim 10, further comprising the step of (f) supplying energy to the metal oxide utilizing an energy source during at least part or all of the period in which applying voltages to the contact electrode and the separation electrode so that the potential difference between the contact electrode and the separation electrode becomes said oxygen reconfiguration voltage, thereby facilitating the adjustment of the oxygen concentration in the metal oxide.

16. Method of driving the gas sensor according to claim 10, further comprising the step of (g) manipulating the electron concentration in the metal oxide by using the potential difference between the contact electrode and the separation electrode during the detection reaction for the target gas, so that the gas detection reaction of the metal oxide is promoted.

17. A method of driving a device including a metal oxide used as a catalyst for a chemical reaction, a contact electrode in contact with the metal oxide, and a separation electrode separated from the metal oxide by a dielectric layer, comprising the following steps of:
(a) applying voltages to the contact electrode and the separation electrode to reduce the oxygen concentration in the metal oxide and increase the concentration of the oxygen vacancies of the metal oxide when the oxygen vacancies of the metal oxide promote a chemical reaction; and
(b) applying voltages to the contact electrode and the separation electrode to increase the oxygen concentration in the metal oxide and increase the concentration of the oxygen vacancies when the oxygen species adsorbed on the metal oxide promote the chemical reaction,
wherein the oxygen concentration in the metal oxide is reconfigured.

18. The method of driving the gas sensor according to claim 17, wherein further comprising the following steps of:
(c) applying voltages to the contact electrode and the separation electrode to reduce the oxygen concentration in the metal oxide and increase the concentration of the oxygen vacancies when oxygen vacancies are consumed by the chemical reaction, thereby restoring the concentration of the oxygen vacancies consumed by the chemical reaction; and
(d) applying voltages to the contact electrode and the separation electrode to increase the oxygen concentration in the metal oxide and increase the concentration of the oxygen species adsorbed on the metal oxide when oxygen species adsorbed on the metal oxide are consumed by the chemical reaction, thereby restoring the concentration of the adsorbed oxygen species consumed by the chemical reaction.

19. The method of driving the gas sensor according to claim 17, further comprising the step of (e) supplying energy to the metal oxide using an energy source during the chemical reaction, so that the adjustment of the oxygen concentration in the metal oxide is promoted.
